(19) United States
(12) Patent Application Publication
(10) Pub. No.: US 2011/0105316 A1
(43) Pub. Date: May 5, 2011

(54) Mixed Metal Oxide Ingredients for Bulk Metal Oxide Catalysts

(75) Inventors: Joseph E. Pelati, Houston, TX (US); Hollie Craig, Seabrook, TX (US); James R. Butler, League City, TX (US)

(73) Assignee: Fina Technology, Inc., Houston, TX (US)

(21) Appl. No.: 12/610,311

(22) Filed: Oct. 31, 2009

(51) Int. Cl. B01J 23/10; B01J 23/00; B01J 23/24; B01J 23/38; B01J 23/02; B01J 23/04; B01J 23/14; B01J 23/20; B01J 23/08; B01J 23/745

(52) U.S. Cl. 502/304; 502/300; 502/302; 502/305; 502/325; 502/340; 502/344; 502/349; 502/353; 502/355; 502/338

(57) ABSTRACT

A bulk metal oxide catalyst can be prepared by combining metal oxide powders or oxide-producing species and reacting selected ingredients prior to their inclusion in the formulation of the catalyst. Mixed metal oxide phases can be designed and prepared for use as an ingredient for a bulk metal oxide catalyst to alter properties for catalytic performance or physical properties that would not be obtained using mixtures of singular metal oxide ingredients.

### CROSS-REFERENCE TO RELATED APPLICATIONS

Not applicable.

### FIELD

The present invention generally relates to bulk metal oxide catalysts used in the conversion of hydrocarbons.

### BACKGROUND

Bulk metal oxide catalysts generally include multiple metal oxide components. Numerous examples of bulk metal oxide catalysts are well known in the art and are generally used for the conversion of hydrocarbons. For instance, bulk metal oxide catalysts are known in the processes of desulfurization, oxidation, ammoxidation, and dehydrogenation, just to name a few.

One particular example of a bulk metal oxide catalyst is a dehydrogenation catalyst having metal oxides of Fe, K, and Ce. This catalyst can be used in the conversion of alkylaromatic hydrocarbons to alkenylaromatic hydrocarbons, such as the conversion of ethylbenzene to styrene. As is the case with many bulk metal oxide catalysts, this catalyst can include numerous promoters, generally in the form of other metal oxides, intended to enhance the physical and/or chemical properties of the catalyst.

Generally, bulk metal oxide catalysts are prepared by combining individual metal oxide powders, mixing, processing, and then calcining the mixture at high temperatures from about 500° C. to 1000° C. There is generally little specificity in the order or groupings in which the ingredients are combined.

According to this method of preparing bulk metal oxide catalysts, desired mixed metal oxide phases and modified metal oxide phases are difficult to predict and/or control in the processing of separate metal oxide ingredients. This unpredictability associated with bulk metal oxide catalyst preparation can be aggravated by the addition of other metal oxide promoters that are detrimental to the formation of desired mixed phases. For example, potassium ferrite phases are known to form in dehydrogenation catalysts during heat treatment and are generally desirable. Certain promoters, such as those intended to enhance the iron oxide phase or to improve physical properties, can adversely affect the formation of the potassium ferrite phases.

Similar problems can occur with many bulk metal oxide catalysts. Certain promoters, when added to the mixture of ingredients used to prepare the catalysts, may impart some benefits to the chemical and/or physical properties of the catalysts while adversely affecting other aspects of the catalysts, generally by limiting or preventing the formation of certain desired metal oxide phases.

Thus, there is a need in the art for greater specificity in the preparation of bulk metal oxide catalysts and for bulk metal oxide catalyst ingredients that enhance the physical and/or chemical properties of the catalyst without adversely affecting other aspects of the catalyst.

### SUMMARY

Embodiments of the present invention involved the use of designed mixed metal oxide ingredients in the preparation of bulk metal oxide catalysts. Designed mixed metal oxide ingredients include one or more metal oxides or metal oxides precursors that are combined and reacted prior to their inclusion in the formulation of the catalyst.

A metal oxide or metal oxide precursor can be any metal compound known in the art as a bulk metal oxide catalyst ingredient. For instance, a metal compound can be chosen from the group consisting of Groups I-VIA and I-VIIIB of the periodic table, and the rare earth metals. The designed mixed metal oxide includes at least two of these metal compounds and can have several, in varying combinations in an oxide form.

In one embodiment, the invention is for a bulk metal oxide catalyst that includes among its ingredients a designed mixed metal oxide.

In another embodiment, the invention is a method of preparing a bulk metal oxide catalyst that includes combining and reacting selected ingredients to form a designed mixed metal oxide, combining said designed mixed metal oxide with other catalyst ingredients, shaping, drying, and calcining the mixture.

The bulk metal oxide catalyst can be any known in the art. For instance, the catalyst can be one that is used in the conversion of alkylaromatic compounds to alkenylaromatic compounds, such as the conversion of ethylbenzene to styrene.

### BRIEF DESCRIPTION OF DRAWINGS

FIG. 1 is a graph of Styrene Selectivity versus EB Conversion for EB to styrene conversions using the catalyst produced in comparative Batch 2.

### DETAILED DESCRIPTION

The present invention provides greater specificity in the preparation of bulk metal oxide catalysts through the use of designed mixed metal oxide ingredients. Designed mixed metal oxide ingredients include selected catalyst ingredients that are separately prepared and reacted prior to their being added to the catalyst formulation.

The synthesis of desired mixed metal oxide ingredients with unique properties in advance of the bulk metal oxide catalyst preparation can facilitate the production of final catalysts having new properties as compared to a catalyst production process having single metal oxide ingredient mixture procedures.

In one embodiment, the invention is for a method of preparing a bulk metal oxide catalyst. Instead of simultaneously mixing all singular ingredients for the catalyst, selected ingredients are pre-mixed and pre-reacted. The pre-reacted ingredients form a designed mixed metal oxide that can then be added to the other catalyst ingredients to ensure that the desired mixed metal phase is in the finished catalyst. The bulk metal oxide catalyst can then be mixed, reacted, shaped, dried, and calcined according to conventional methods known in the art.

In one embodiment, the designed mixed metal oxide includes a bulk metal oxide catalyst ingredient combined with one or more other metal oxides that affect the properties that the ingredient imparts to the catalyst. When some ingredients are used individually as an ingredient in a catalyst, they can produce poor results. Instead, such ingredients can be modified with one or more other metal oxides to create a new ingredient and ultimately an improved catalyst. The ingredient and the other metal oxides can be mixed and reacted until a desired mixed metal oxide phase is produced. The designed mixed metal oxide can have new chemical and physical properties, and can be considered a new ingredient for the preparation of a bulk metal oxide catalyst.

In another embodiment, the designed mixed metal oxide includes a bulk metal oxide catalyst ingredient combined with one or more other metal oxides that affect the ingredient's stability. Some ingredients can have poor stability when used as an individual ingredient as a catalyst. The poor stability can manifest itself in the ingredient being volatile at reactor conditions or being easily lost from the catalyst over time. Such ingredients can be modified with one or more other metal oxides to create a stabilized ingredient. The ingredient and the one or more other metal oxides can be mixed and reacted until a desired mixed metal oxide phase is produced. The designed mixed metal oxide can have new properties, such as greater stability, when used in the preparation of a bulk metal oxide catalyst. For example, potassium, an ingredient commonly included in the formulations of styrene catalysts, can be volatile at reactor conditions and can be easily lost during a catalyst run, thereby deactivating the styrene catalyst. Potassium can instead be combined with a support material such as alumina before being used in a styrene catalyst preparation. The modified potassium can exhibit greater stability and can, in turn, increase the life of the styrene catalyst.

In another embodiment, the designed mixed metal oxide can be a mixed metal oxide co-catalyst. The co-catalyst can be prepared according to conventional methods known in the art and can then be used as an ingredient in the preparation of a bulk metal oxide catalyst. The co-catalyst can enhance the chemical and physical properties of the bulk metal oxide catalyst. Examples of mixed metal co-catalysts that can be used include water gas shift catalysts, oxidation catalysts, dehydrogenation catalysts, de-coking catalysts, and catalysts for hydrogen transfer reactions. For instance, potassium aluminate can be used in the preparation of a styrene catalyst to enhance de-coking.

In another embodiment, the designed mixed metal oxide can be a specialized ingredient that can only be added to the bulk metal oxide catalyst formulation by separate preparation, then subsequent addition as a catalyst ingredient. Such specialized ingredients can be added to affect the chemical and/or physical properties of the bulk metal oxide catalyst. For instance, beta aluminates are plate-like crystals that can have high temperature stability and high porosity. They can be used in bulk metal oxide catalysts, such as styrene catalysts. Beta aluminates are generally formed by combining alkali metals with alumina and calcining the mixture at high temperatures. Other specialized ingredients can be prepared according to the procedure known in the art and used as ingredients in the preparation of bulk metal oxide catalysts.

The designed mixed metal oxide ingredients can be used in the formulation of any bulk metal oxide catalyst known in the art. Bulk metal oxide catalysts are used for a variety of processes, such as desulfurization, oxidation, ammoxidation, and dehydrogenation, just to name a few. The present invention can be useful for any bulk metal oxide catalyst that benefits from greater specificity in its preparation, regardless of its intended use.

One bulk metal oxide catalyst for which this invention is useful is a catalyst for the dehydrogenation of alkylaromatics to alkenylaromatics. One example of this type of catalyst is a styrene catalyst that promotes the conversion of ethylbenzene to styrene. Such catalysts are generally prepared by mixing iron oxide, potassium oxide, cerium oxide, and other ingredients. The mixture is then shaped, dried, calcined, and placed in a reactor. Dehydrogenation reactions can take place, in one non-limiting example, at a temperature of from 540° C. to 660° C., a pressure in the range of sub-atmospheric to around atmospheric pressure, and a LHSV of from 0.1 hr⁻¹ to 5 hr⁻¹.

Designed mixed metal oxides that can be used in the present invention include at least one metal oxide or one metal oxide precursor. A metal oxide precursor forms an oxide phase at high temperatures, such as those used in calcining. A metal oxide or metal oxide precursor can be any metal compound known in the art as a bulk metal oxide catalyst ingredient. For instance, a metal compound can be selected from the group consisting of Groups I-VIA, I-VIIIB, of the periodic table and the rare earth metals. The designed mixed metal oxide includes at least one of these metal compounds and can have several, in varying combinations.

A bulk metal oxide catalyst according to the present invention contains from 0.1 to 85 wt % of a designed mixed metal oxide, optionally from 1.0 to 75 wt %, optionally from 5.0 to 50 wt %, optionally from 10.0 to 40 wt %. The other catalyst ingredients can include conventional ingredients known in the art as well as any promoters and/or stabilizers that affect physical and/or chemical properties.

### Example

### Batch 1

A bulk metal oxide catalyst was prepared by combining a pre-formed mixed metal oxide, magnesium aluminate, with other ingredients followed by forming and calcination. The pre-formed magnesium aluminate amounts to about one quarter of the ingredients by weight. The catalyst was prepared by mixing the powdered ingredients, adding water, followed by extruding into formed cylindrical shapes. The final step is a high temperature calcination at 775° C. for four hours. The ingredient list is shown in Table 1.

TABLE 1

| Ingredient | wt grams |
|---|---|
| FeO(OH) yellow iron | 400 |
| oxide | |
| K2CO3 | 190 |
| CaCO | 60 |
| Ce2(CO3)3-5 H2O | 110 |
| MgAl2O4 | 230 |
| MoO3 | 10 |
| methyl cellulose | 10 |
| graphite | 25 |
| Cement | 40 |
| sum | 1075 |

This material was evaluated in an isothermal dehydrogenation reactor at a LHSV of 3 h⁻¹, a pressure of 700 mbar, an 8:1 steam-to-hydrocarbon ratio, and at a temperature of 630° C. The material was evaluated for the ability to dehydrogenate ethylbenzene to styrene. The result from Batch 1 showed a 65% ethylbenzene conversion with 97.4% molar selectivity to styrene (normalized for liquid products only). This result compares favorably with Comparative Batch 2 made from similar ingredients but without the pre-formed mixed metal oxide.

### Comparative Batch 2

A bulk metal oxide catalyst with similar ingredient percentages but without the pre-formed mixed metal oxide can be used as a comparative example. The catalyst was prepared by mixing the powdered ingredients, adding water, followed by extruding into formed cylindrical shapes. The final step was high temperature calcination at 775° C. for four hours. The ingredient list is shown in Table 1.

TABLE 2

| Ingredient | wt grams |
|---|---|
| FeO(OH) yellow iron | 40 |
| oxide | |
| K2CO3 | 19 |
| CaCO | 6 |
| Ce2(CO3)3-5 H2O | 11 |
| Al2O3 | 23 |
| MoO3 | 1 |
| methyl cellulose | 0.5 |
| stearic acid | 0.75 |
| graphite | 0.75 |
| cement | 4 |
| sum | 106 |

The catalyst produced from Batch 2 was analyzed in an isothermal bench scale reactor for ethylbenzene dehydrogenation to styrene at various reactor conditions. Steam to ethylbenzene ratios ranged between 7 to 9 and temperatures from 590° C. and 630° C. The LHSV was held at 3 hr⁻¹ and the partial pressure of EB/H₂O was 700. The reactor pressure was set at 1350 mbar.

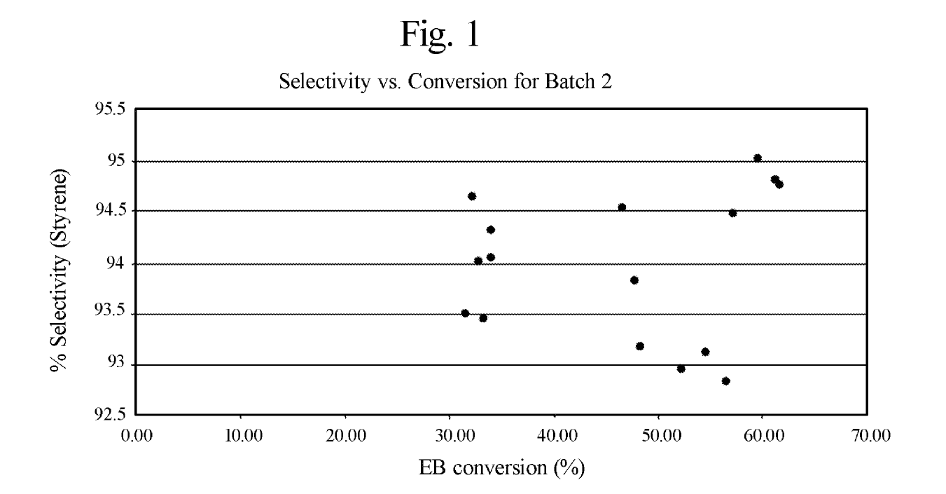

FIG. 1 is a graph of Styrene Selectivity versus EB Conversion for EB to styrene conversions using the catalyst produced in Batch 2. Ethylbenzene conversions ranged from about 30% to about 63% while the Styrene Selectivity ranged from about 93% to about 95%.

The term “catalyst” refers to any bulk metal oxide catalyst known in the art, unless explicitly stated otherwise.

As used herein, the term “designed mixed metal oxide” refers to any metal oxide or combinations of metal oxides that are mixed and reacted to a desired phase prior to their inclusion in the preparation of a catalyst.

Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A bulk metal oxide catalyst comprising:
at least one designed mixed metal oxide.

2. The catalyst of claim 1, wherein the designed mixed metal oxide is prepared and reacted prior to its inclusion in the formulation of the bulk metal oxide catalyst.

3. The catalyst of claim 1, wherein the at least one designed mixed metal oxide comprises at least one metal compound selected from the group consisting of Groups I-VIA and I-VIIIB of the periodic table, and the rare earth metals.

4. The catalyst of claim 1, wherein the designed mixed metal oxide comprises at least two metals.

5. The catalyst of claim 4, wherein the at least two metals are selected from the group consisting of Groups I-VIA and I-VIIIB of the periodic table, and the rare earth metals.

6. The catalyst of claim 1, wherein the designed mixed metal oxide comprises at least two metal compounds that forms a metal oxide phase during preparation of the designed mixed metal oxide.

7. The catalyst of claim 1, wherein the bulk metal oxide catalyst is used in a reactor for the conversion of alkylaromatic hydrocarbons to alkenylaromatic hydrocarbons.

8. The catalyst of claim 1, wherein the bulk metal oxide catalyst is used in a reactor for the conversion of ethylbenzene to styrene.

9. The catalyst of claim 1, wherein the designed mixed metal oxide comprises from 0.1 to 85 wt % of the catalyst.

10. The catalyst of claim 1, further comprising:
at least one conventional ethylbenzene dehydrogenation ingredient.

11. The catalyst of claim 10, wherein the at least one conventional ethylbenzene dehydrogenation ingredient is selected from the group consisting of Fe, K, Ce, and combinations thereof.

12. A method for preparing a bulk metal oxide catalyst comprising:
combining and reacting selected ingredients to form a designed mixed metal oxide;
combining said designed mixed metal oxide with other catalyst ingredients to form a mixture;
and shaping, drying, and calcining the mixture.

13. The method of claim 12, wherein the designed mixed metal oxide comprises at least one metal oxide or metal compound selected from the group consisting of groups I-VIA and I-VIIIB of the periodic table, and the rare earth metals.

14. The method of claim 12, wherein the designed mixed metal oxide comprises at least two metal oxides or metal compounds that form an oxide during preparation of said designed mixed metal oxide.

15. The method of claim 12, wherein the bulk metal oxide catalyst is capable of catalyzing the conversion of alkylaromatic hydrocarbons to alkenylaromatic hydrocarbons.

16. The method of claim 12, wherein the bulk metal oxide catalyst is capable of catalyzing the conversion ethylbenzene to styrene.

17. The method of claim 12, wherein the designed mixed metal oxide comprises from 0.1 to 85 wt % of the bulk metal oxide catalyst.

18. The method of claim 12, wherein the other catalyst ingredients comprises at least one conventional ethylbenzene dehydrogenation ingredient.

19. The method of claim 18, wherein the at least one conventional ethylbenzene dehydrogenation ingredient is selected from the group consisting of Fe, K, Ce, and combinations thereof.

20. A bulk metal oxide catalyst comprising:
at least one designed mixed metal oxide containing at least one metal selected from the group consisting of Groups I-VIA and I-VIIIB of the periodic table, and the rare earth metals;
at least one conventional ethylbenzene dehydrogenation ingredient selected from the group consisting of Fe, K, Ce, and combinations thereof
wherein the designed mixed metal oxide is prepared and reacted prior to its inclusion in the formulation of the bulk metal oxide catalyst; and
wherein the at least one metal forms a metal oxide phase during preparation of the designed mixed metal oxide.
